(19) United States
(12) Patent Application Publication
(10) Pub. No.: US 2019/0183095 A1
(43) Pub. Date: Jun. 20, 2019

(54) SYSTEM AND METHOD FOR SURVEYING WILDLIFE WITH AN UNMANNED AERIAL VEHICLE

(71) Applicant: Cody Trahern, Granbury, TX (US)

(72) Inventor: Cody Trahern, Granbury, TX (US)

(21) Appl. No.: 16/221,483

(22) Filed: Dec. 15, 2018

Related U.S. Application Data
(60) Provisional application No. 62/599,407, filed on Dec. 15, 2017.

(51) Int. Cl. A01K 29/00; B64C 39/02; G01J 5/00; G01J 5/04

(52) U.S. Cl. CPC A01K 29/005; B64C 39/024; G05D 1/0094; G01J 5/047; G01J 5/0025

(57) ABSTRACT

A method of surveying wildlife within a predetermined geographical area, the method includes determining one or more plots for surveying, the one or more plots being associated with the geographical area; providing an unmanned aerial vehicle (UAV) having one or more thermal imaging cameras secured thereon and in communication with a processor, the one or more thermal imaging camera and processor to capture and store images for analysis; providing a flight mission software, the flight mission software allowing for programming of a way points, a speed, and an altitude of flight; setting the way points within one of the one or more plots, the speed, and the altitude, all being based on capabilities of the thermal imaging camera; activating a flight path of the UAV; capturing the images via the thermal imaging camera and processor, the images showing thermal depictions of wildlife located within the plot; and creating a report based on the images captured.

### BACKGROUND

### 1. Field of the Invention

The present invention relates generally to wildlife survey systems, and more specifically, to a method and system for surveying wildlife within a predetermined geographical area with an unmanned aerial vehicle having a thermal imaging technology incorporated therein.

### 2. Description of Related Art

Wildlife survey systems are well known in the art and are used to estimate wildlife population within a geographical area. Determining the wildlife population is vastly important for maintenance of a wildlife population. Conventional means of wildlife survey involve manual surveying, for example, FIG. 1 depicts a simplified schematic of a wildlife survey system 101 having a plot of land 103 with a plurality of wildlife 105a-d therein. One common means of counting wildlife 105a-d is through use of an access road 107, wherein a spotlight is used to see reflections of the eyes of the wildlife. Based on the count of wildlife, algorithms and calculations are used to estimate the total population.

In FIG. 2, a flowchart 201 depicts this process, wherein wildlife are viewed from an access road and manually counted, as shown with boxes 203, 205. A report is then created based on calculations of the count, as shown with box 207.

One of the problems commonly associated with system 101 is inaccuracies in the wildlife count. For example, tree lines 109a-b can block visibility of a large portion of the wildlife population, thereby making the calculations wildly inaccurate.

Accordingly, although great strides have been made in the area of wildlife surveying, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified diagram of a common wildlife survey system;

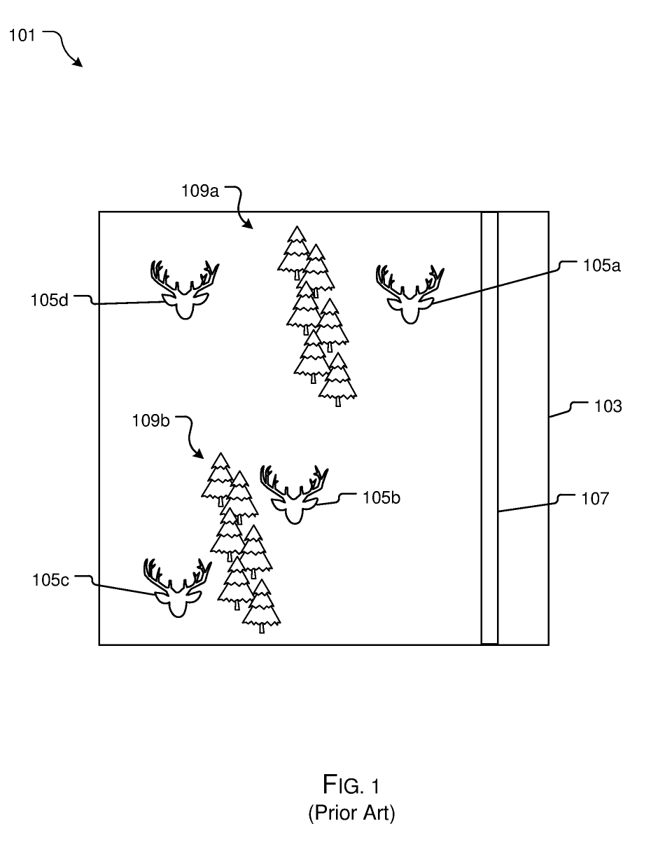

FIG. 2 is a flowchart of the method of use of FIG. 1;

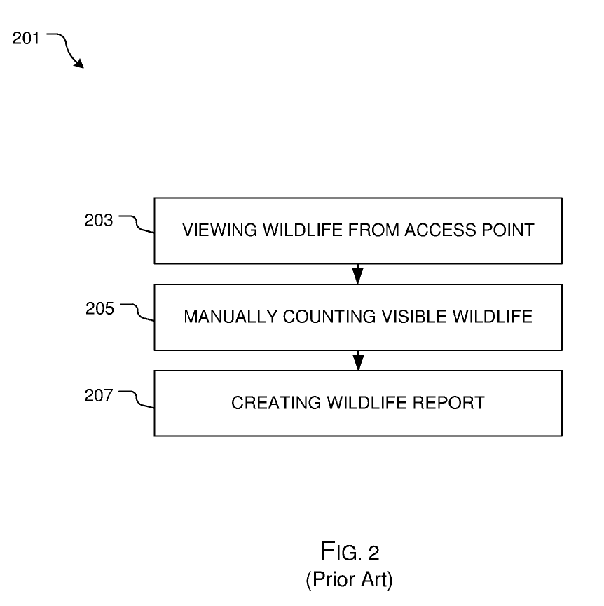

FIG. 3 is a simplified schematic of a wildlife survey system in accordance with a preferred embodiment of the present application; and

FIG. 4 is a flowchart of the method of FIG. 3.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional wildlife systems. Specifically, the present invention provides a means to improve the accuracy of a final report via use of a UAV with a thermal imaging camera. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

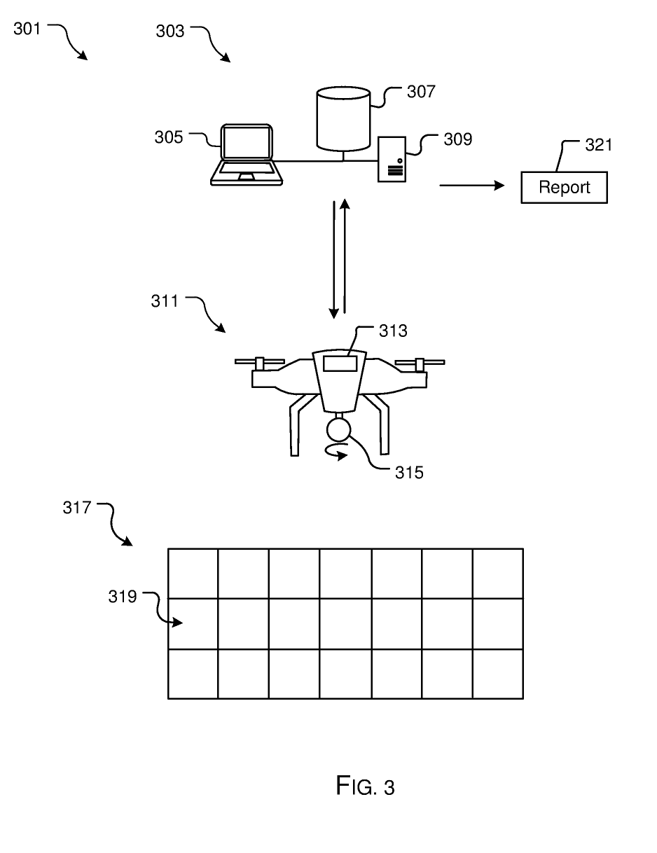

Referring now to the drawings wherein like reference characters identify corresponding or similar elements throughout the several views, FIG. 3 depicts a simplified schematic of a wildlife surveying system 301 in accordance with a preferred embodiment of the present application. It will be appreciated that system 301 overcomes one or more of the above-listed problems commonly associated with conventional wildlife surveying systems.

In the contemplated embodiment, system 301 includes a control center 303 having one or more of a computer 305, a database 307, and a server 309 configured to implement data analysis and provide a means to control an unmanned aerial vehicle (UAV) 311 via a processor 313. It should be understood that the various components associated with control center 303 can alternatively be incorporated into the UAV, or can be separate components as necessary to control and program UAV 311.

UAV 311 includes a camera 315, such as a thermal imaging camera. In some embodiments, the camera includes 360 degrees of rotation, however other contemplated embodiments include fixed cameras or cameras with rotational movement anywhere from 0-360 degrees. The camera 315 is configured to receive commands to capture a plurality of images along a path of the UAV. In the preferred embodiment, a flight mission software is implemented into control center 303 to program a flight path of UAV 311. The preferred flight mission software allows for setting one or more of an altitude of flight, a plurality of way points, and a speed. It should be appreciated that the setting of altitude is important to ensure that the camera 315 has clear visibility to a ground surface.

In the preferred embodiment, UAV 311 is programmed to survey a predetermined geographical area 317. Depending on the size of the geographical area 317, the area can be broken into a plurality of smaller, more manageable plots 319, wherein UAV will be programmed to survey each plot individually.

After completion of the flight path and the collection of a plurality of images, the data collected can be used to create a report 321 for the survey. It should be appreciated that various pieces of information can be included in the report, such as a break down of female to male wildlife. It should be understood that the ratio of female to male wildlife can be determined based on body temperature, as determined via the thermal imaging camera, wherein male wildlife show as a higher temperature than female.

It should be appreciated that one of the unique features believed characteristic of the present application is the use of a UAV with a thermal imaging camera to provide a plurality of images over a geographical area.

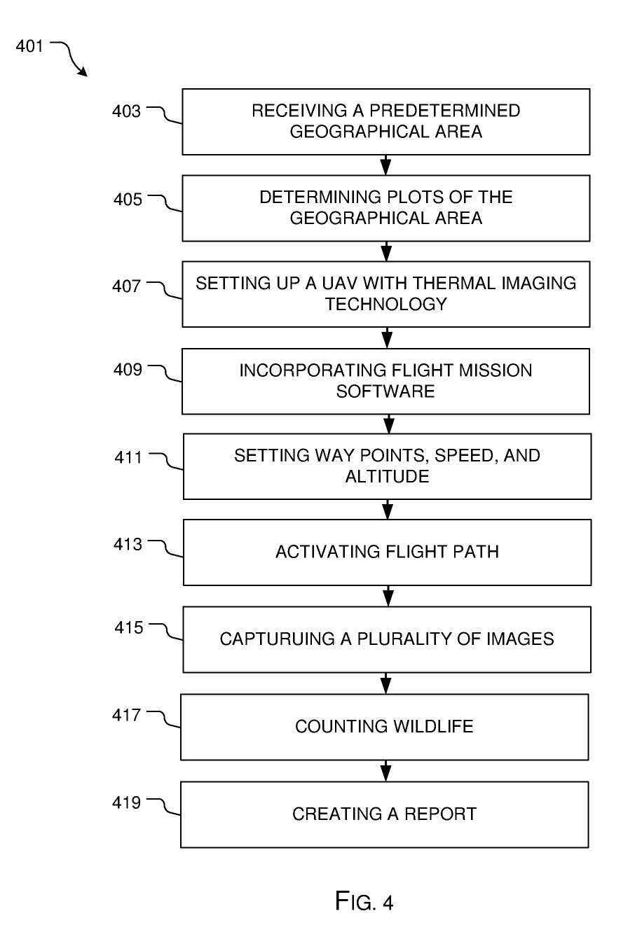

In FIG. 4, a flowchart 401 depicts the method of wildlife surveying according the present invention. First, the geographical area must be determined, as shown with box 403. It should be appreciated that this information may be provided by a landowner, a governmental body, or can be determined via a plurality of other resources. Depending on the size of the geographical area, a plurality of plots are created, as shown with box 405. It should again be appreciated that this step is achieved via known technology, such as GIS software and the like.

A UAV is set up with a thermal imaging camera, wherein the thermal imaging camera can include anywhere from 0-360 degrees of rotation, as shown with box 407. A flight mission software is used to program the UAV with one or more of a speed, a plurality of way points, and an altitude, as shown with boxes 409, 411. The UAV flight path is activated, wherein the UAV travels and captures a plurality of images, as shown with boxes 413, 415. The wildlife are counted, as shown with box 417. One means of counting the wildlife is during the live flight of the UAV, however, once the UAV has completed its path, the plurality of images can be reviewed and re-counted to ensure accuracy. A report is then created based on the counted wildlife, as shown with box 419. The report can include information such as wildlife numbers and a ratio of male to female.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A method of surveying wildlife within a predetermined geographical area, the method comprising:
determining one or more plots for surveying, the one or more plots being associated with the geographical area;
providing an unmanned aerial vehicle (UAV) having one or more thermal imaging cameras secured thereon and in communication with a processor, the one or more thermal imaging camera and processor configured to capture and store images for analysis;
providing a flight mission software, the flight mission software allowing for programming of a plurality of way points, a speed, and an altitude of flight;
setting the plurality of way points within one of the one or more plots, the speed, and the altitude, all being based on capabilities of the thermal imaging camera;
activating a flight path of the UAV;
capturing the images via the thermal imaging camera and processor, the images showing thermal depictions of wildlife located within the plot; and
creating a report based on the images captured.

2. The method of claim 1, wherein the capturing of the images is achieved via 0 to 360 degree rotation of the thermal imaging camera.

3. The method of claim 1, wherein the report includes an analysis of a ratio of male to female wildlife;
wherein male and female wildlife are determined based on body temperature as determined via the thermal imaging camera.

4. A system for surveying wildlife in a predetermined geographical location, the system comprising:
a control center;
a processor having software for setting waypoints, altitude, and speed associated with a flight path, the processor configured to be controlled via the control center;
an unmanned aerial vehicle (UAV) having a thermal imaging camera configured to capture images for transmitting to the processor, the UAV being controlled by the control center to complete the steps of:
receiving the flight path;
flying according to the flight path; and
capturing a plurality of images for analysis by the control center;
a report created by the control center based on the plurality of images;
wherein the report provides information relating to a wildlife population within the predetermined geographical location.

5. The system of claim 1, wherein the capturing of the images is achieved via 0 to 360 degree rotation of the thermal imaging camera.

6. The system of claim 1, wherein the report further comprises:
an analysis of a ratio of male to female wildlife;
wherein male and female wildlife are determined based on body temperature as determined via the thermal imaging camera.
